(19) United States
(12) Patent Application Publication
(10) Pub. No.: US 2010/0211419 A1
(43) Pub. Date: Aug. 19, 2010

(54) Systems and Methods to Present Travel Options

(75) Inventors: Oleg Y. NICKOLAYEV, Redwood City, CA (US); Alexander DENNISOV, Foster City, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 12/371,548

(22) Filed: Feb. 13, 2009

(51) Int. Cl. G06Q 50/00; G06F 17/30; G06Q 99/00; G06Q 10/00

(52) U.S. Cl. 705/5; 707/E17.014; 705/1.1

(57) ABSTRACT

Systems and methods to present travel options in response to a search request. In one aspect, after a computer system receives a search request from a user, the computer system determines a plurality of travel options in response to the search request. The computer system then presents the travel options using a chart having a dimension graphically representing travel times of the travel options, such as in a Gantt chart with a graphical timescale, which may have a representation of an analog clock.

### FIELD OF THE TECHNOLOGY

At least some embodiments of the disclosure relate to data processing systems for the presentation of travel options in response to search requests.

### BACKGROUND

Currently, web applications for travel display flight search results in tabular text form, which is very verbose and contains a lot of information that is not necessary for the initial decision about which flight to choose. Displays such as these are useless on mobile devices that have a small display size. Many providers supply a subset of the data from such displays on mobile devices, but then the provider loses the ability to show comprehensive data on the small screen as well.

### BRIEF DESCRIPTION OF THE DRAWINGS

The embodiments are illustrated by way of example and not limitation in the figures of the accompanying drawings in which like references indicate similar elements.

FIG. 1 illustrates a system for the presentation of options related to travel arrangements according to one embodiment.

FIGS. 2-5 illustrate examples of layouts to present travel options according to one embodiment.

FIG. 6 illustrates a method to present travel options according to one embodiment.

FIG. 7 shows a data processing system which can be used in various embodiments.

### SUMMARY OF THE DESCRIPTION

Systems and methods to present travel options in response to a search request are described herein. Some embodiments are summarized in this section.

In one embodiment, a computer-implemented method, comprising: receiving a search request; determining a plurality of travel options in response to the search request of a user; and presenting the travel options using a chart having a dimension graphically representing travel times of the travel options, using a computer.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

One embodiment of the disclosure provides a web application that allows individual travelers to search for flights, hotels, cars, and other travel-related services and accommodations in a clearer, more efficient and easy-to-use format, thus making sorting and choosing of travel options, such as flight search results, much easier for the end user, and as a result, making the web application that uses this technology to be more user friendly in the travel area, for both mobile and regular web.

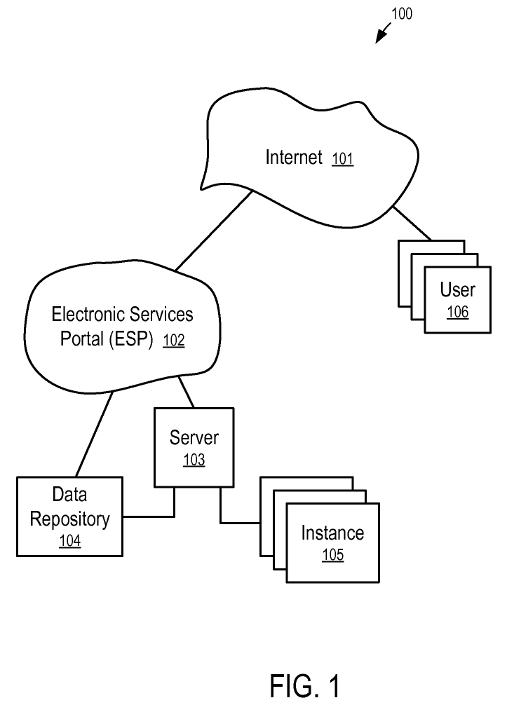

FIG. 1 shows an exemplary overview of a system 100 according to one embodiment of the disclosure. In FIG. 1, an electronic services portal (ESP) 102 connects to a server 103 and a data repository 104. The server 103 hosts software instances (e.g., 105), which, depending on the implementation of the system 100, may be one, several, or many instances. These software instances are to be considered only exemplary indications of how the software could be installed in server 103 and how it could work in conjunction with ESP 102, personal information managers (PIMs, not shown), and main data repository 104. The EPS 102 connects via Internet 101 to system users 106 (e.g., 106) and suppliers (e.g., 107). These connections could also be through direct connection, through a phone system, or through any other suitable networking method, known or to be invented, such as a local area network, an intranet, a wireless telecommunication network, etc.

In one embodiment, the EPS 102 includes a web site to communicate with the users 106 using a web browser. The users 160 may or may not register with the ESP 102, to search and view available travel options, such as flights, hotels, cars, parking, etc.

In one embodiment, applications running on the devices used by the users 106 (not shown in FIG. 1) communicate with the EPS 102 to submit search requests and to receive presentations of the search results.

In one embodiment, the data repository 104 stores data representing available travel options and/or the preferences of the uses 106. The data repository 104 may be a centralized database, a network of peer to peer connected computers, and/or a set of web sites.

In one embodiment, the data repository 104 stores calendar items for the users 106, which can be displayed with the search results to provide an improved way to present the travel options in relation with schedule activities of the users 106.

In some embodiments, the calendar items are stored on the devices used by the users 106, such as the personal digital assistances (PDA), cellular phones, notebook computers, etc, which run calendar applications. The user devices are further configured to selectively present the calendar items with the search results, once the search results are retrieved from the ESP 102.

For example, in one embodiment a search user interface is integrated a calendar application to present the travel options in the context of scheduled items in the calendar application of the corresponding user 106.

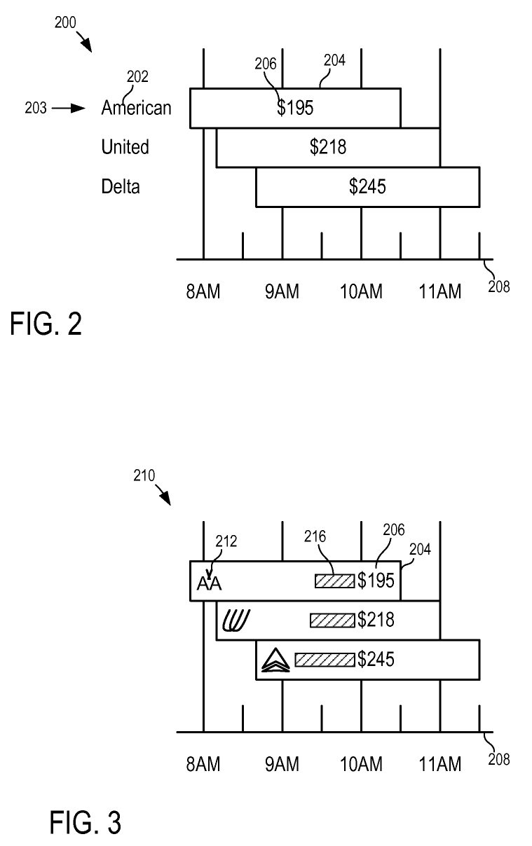

FIG. 2 shows an exemplary section 200 of a graphical display of travel options according to one embodiment. In FIG. 2, the flight options are organized into a table 200, with rows (e.g., 203) corresponding to the connecting origin and destination of one or more flights. In the example of FIG. 2, three rows of options are illustrated, corresponding airline ticket offers from three airlines (e.g., American, United, and Delta). In general, more or less travel options can be presented in the table 200.

In table 200 of this exemplary embodiment, a timescale 208 is used to present the time information related to the travel options. An addition column 202 is used to identify the carriers of the travel options presented in the timescale 208. Other columns may be added to display information such as prices, seat availability, availability of flight connections, restrictions, promotional offers or discounts, etc. For example, a column of total price for the options represented by a row of one or more connecting options can be presented in a separate column next to the time scale 208.

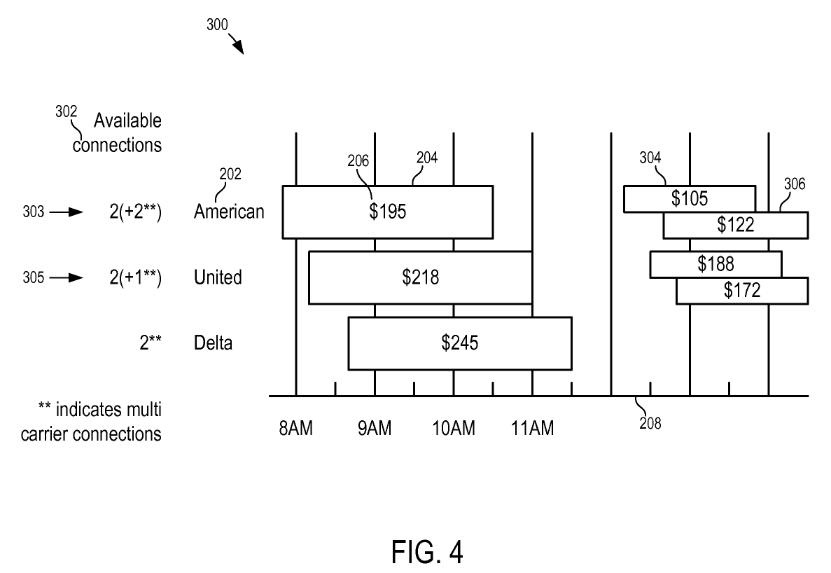

In FIG. 2, flight departure and arrival times are displayed graphically by bars (e.g., 204), spanning the time between flight arrival and departure. In some cases, especially in case of connections, multiple bars can be shown laterally, with the gap identifying connection times, as described in greater detail below, in the discussion of FIG. 4.

In FIG. 2, the prices (e.g., 206) of the corresponding travel options are displayed on the bars (e.g., 204) that represent the time information of the corresponding travel options. Thus, the information can be presented in a concise and user friendly way within a limited display area.

In FIG. 2, the prices are displayed in text. In other embodiments, the prices can be display via symbols or colors that represent the range of the prices. For example, a number of “$” symbols can be used to indicate the range of the prices; and the “$” symbols can be presented within the corresponding bars (e.g., 204). For example, a shade of color between green and red may be used to indicate the price range; and the shade of color can be used to paint the corresponding bars (e.g., 204) that represent the time information of the corresponding travel options. The color shade may be determined based on predetermined price scale, or based on relation with the lowest and highest prices of the options presented in the table 200.

In FIG. 3, the airlines are presented by the symbols (e.g., 212) presented on the bars (e.g., 204) that represent the time of the corresponding flights; and the prices are presented via a column of price bars (e.g., 216) that are overlaid on the timeline bars (e.g., 204) that represent the duration of the corresponding flights. The text version of the prices (e.g., 206) is optional, when the prices are represented by the price bars (e.g., 216). In some embodiments, the price bars are not displayed when the text version of the prices (e.g., 206) is displayed.

In some embodiments, the symbols (e.g., 212) of the airlines can be placed outside the timeline bars (e.g., 204), closed to one of the ends of the timeline bars (e.g., 204). In some embodiments, the symbols (e.g., 212) can be placed in a separate column outside the timescale 208.

FIG. 4 shows an exemplary section 300 of a graphical display of travel options according to an embodiment. In FIG. 4, multiple connection options result in organization of data into a Gantt or similar chart, showing, on the right side of rows 303 and 305, two pairs of two flights each as connecting flight options for the American and the United flights. Each pair of connecting flights includes one flight with a small gap (tight connection) (e.g., between 204 and 304), and one flight with a larger gap (safe connection) (e.g., between 204 and 306. Thus, the user can very easily visually compare various flight options, both in terms of departure and arrival times as well as in terms of duration, number of connections, and prices, as shown in timeline bars presented on the timescale 208. Column 302 shows availability of connections from same carrier or multi-carriers or other data as needed or as requested in a user's personal configuration (not shown). Other data may include, but is not limited to, arrival or departure gates, seat availability, etc. In some embodiments, column 302 of available connections may be omitted.

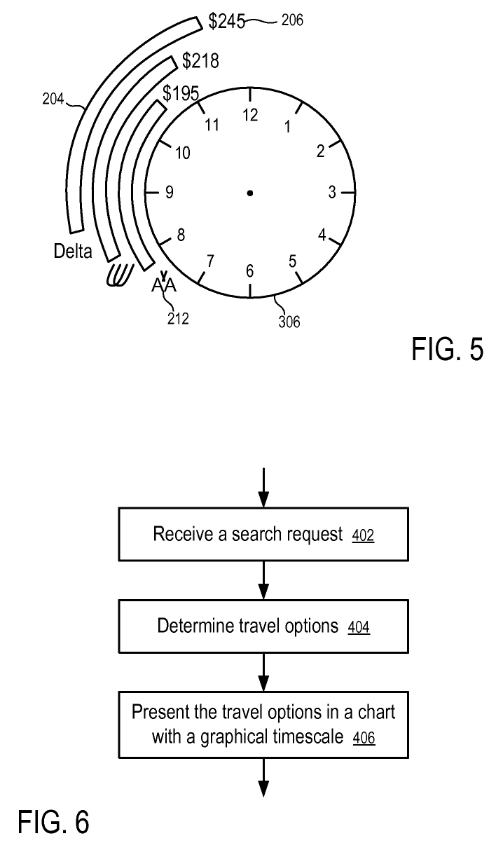

FIG. 5 shows a graphical display that makes information even more concise. In FIG. 5, the timescale 306 is represented as a clock, in a circular fashion and with lines drawn as segments of a circle. The timeline bars (e.g., 204) have a shape conforming to the shape of the clock. The two ends of the timeline bars correspond to the departure and arrival times of the corresponding flights. The airlines are indicated by their icons (e.g., 212) presented near one end of the timeline bars; and the prices (e.g., 206) of the flights are presented as text near the other end of the timeline bars.

This approach is advantageous because it is intuitive for many users to think of time in this way, as everyone is accustomed to analog clocks. A circular representation also consumes finite space both horizontally and vertically, making it especially suitable for mobile devices.

It is preferred to limit the number of options presented in the format as illustrated in FIG. 5, to avoid making the display too messy. In one embodiment, the time display is limited to a 12-hour time interval. For a presentation of a time period longer than a 12-hour time interval, the morning (A.M.) portion can be placed inside the circle representing the clock; and afternoon (P.M.) portion can be placed outside the circle representing the clock. In some embodiments, the timeline bar may spiral inwards or outwards to allow the timeline to go more than a full turn around the clock to span a time interval longer than 12 hours. In some embodiments, each schedule may include a predetermined number of tracks to show the options a time period longer than 12 hours (e.g., one track for the morning and the one track for the afternoon); and the timeline 204 can be represented as a solid curve on the corresponding track. Indications of the tracks can be graphically displayed (e.g., as doted lines, or light trace of lines).

Further, the price may be indicated by the color of the time bar (e.g., green for cheap and red for expensive tickets, or a shade of color between blue and red to represent the price). Alternatively or in combination, the prices can be presented via straight price bars presented near the clock. For example, the timelines can be presented along the tracks that are concentric contours surrounding the clock; and the price bars may start from a position on the corresponding tracks of the timelines and point to a same direction to allow easy comparison (e.g., horizontal or vertical price bars).

In some embodiments, color overlays, transparencies, etc. are used to overlay information on top of each other to provide a concise presentation. The Gantt chart for the display of the travel options may use logos, layover, color, etc. to organize the display of other information around the time information of the travel options.

In another instance, a user's person's daily calendar is also represented in this format, for flights, dinner, entertainment, etc. The search results of travel options can be presented in the context of the calendar items of the user.

The examples of FIGS. 2-5 illustrate the presentation of travel options in terms of scheduled flights from airlines, other travel options, such as bus, train, rental car, etc., can also be represented by similar charts. Thus, the disclosure is not limited to the display of airline flight information.

FIG. 6 illustrates a method to present travel options according to one embodiment. In FIG. 6, after a computer system receives (402) a search request from a user, the computer system determines (404) a plurality of travel options in response to the search request. The computer system then presents (406) the travel options using a chart having a dimension graphically representing travel times of the travel options, such as in a Gantt chart with a graphical timescale, which may have a representation of an analog clock.

In one embodiment, the chart includes a plurality of bars graphically representing travel time periods between departure and arrival of the travel options; and cost indicators, such as the prices of the airline tickets, etc., are overlaid on the bars. The cost indications may include text to show a price associated with traveling via a travel option represented by a corresponding bar, or a shade of color to indicate a price range associated with traveling via a travel option represented by a corresponding bar. In one embodiment, the computer system determines the shade of color based on the price relative to prices of two of the travel options.

In one embodiment, the travel options comprise scheduled flights from airlines; and the bars represent the departure and arrival times of the flights. The bars may be arranged in a column and presented substantially parallel to each other. The bars may be substantially straight or curved to conform to a shape of a clock, with the ends of the bars positioned relative to the clock to indicate departure and arrival times of corresponding travel options represented by the bars.

In one embodiment, on the bars that represent the time information of the travel options, the chart shows transportation carriers associated with the travel time periods represented by the bars. The transportation carriers, such as airlines, can be represented by their icons, or in text.

In one embodiment, the chart includes a column to indicate transpiration carriers associated with the travel time periods represented by the bars and at least one column to list at least one of: gate information, seat availability, and availability of flight connections.

In one embodiment, the computer system also presents at least one a calendar item of the user on the timescale on which the time information of the travel options is presented.

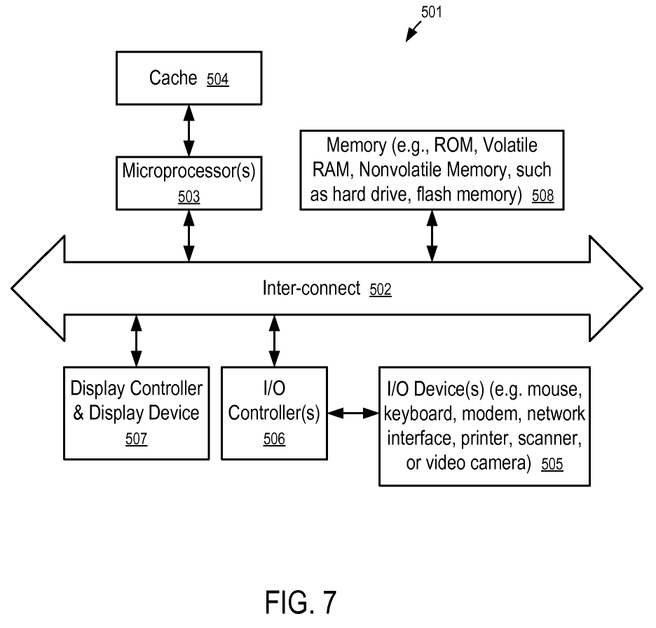

FIG. 7 illustrates a data processing system which can be used in various embodiments. While FIG. 7 illustrates various components of a computer system, it is not intended to represent any particular architecture or manner of interconnecting the components. Some embodiments may use other systems that have fewer or more components than those shown in FIG. 7.

In one embodiment, a server data processing system illustrated in FIG. 7 implements at least one of the components shown in FIG. 1, such as the electronic services portal (ESP) 102, the server 103, and/or the data repository 104. In one embodiment, a user terminal as a data processing system as illustrated in FIG. 7 is used by the users 106 to access the software instance 105.

In FIG. 7, the data processing system 501 includes an inter-connect 502 (e.g., bus and system core logic), which interconnects a microprocessor(s) 503 and memory 508. The microprocessor 503 is coupled to cache memory 504 in the example of FIG. 7.

The inter-connect 502 interconnects the microprocessor(s) 503 and the memory 508 together and also interconnects them to a display controller and display device 507 and to peripheral devices such as input/output (I/O) devices 505 through an input/output controller(s) 506. Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect 502 may include one or more buses connected to one another through various bridges, controllers and/or adapters. In one embodiment the I/O controller 506 includes a USB (Universal Serial Bus) adapter for controlling USB peripherals, and/or an IEEE-1394 bus adapter for controlling IEEE-1394 peripherals.

The memory 508 may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A computer-implemented method, comprising:
receiving a search request from a device of a user;
determining, via a server, a plurality of travel options in response to the search request; and
sending, from the server, a presentation to the device, the presentation to display the travel options using a chart having a dimension graphically representing travel times of the travel options, the dimension including a timescale, and wherein the presentation is to further display at least one calendar item of the user on the timescale, the calendar item existing prior to receiving the search request.

2. The method of claim 1, wherein the chart comprises a Gantt chart of the travel times.

3. The method of claim 1, wherein the chart includes a plurality of bars graphically representing travel time periods between departure and arrival of the travel options.

4. The method of claim 3, wherein the chart has cost indicators overlaid over the bars.

5. The method of claim 4, wherein the cost indicators comprise text to show a price associated with traveling via a travel option represented by a corresponding bar.

6. The method of claim 4, wherein the cost indicators comprise a shade of color to indicate a price range associated with traveling via a travel option represented by a corresponding bar.

7. The method of claim 6, further comprising:
determining the shade of color based on the price relative to prices of two of the travel options.

8. The method of claim 3, wherein the travel options comprises scheduled flights from airlines; and the bars represent departure and arrival times of the flights.

9. The method of claim 3, wherein the bars are arranged in a column and presented substantially parallel to each other.

10. The method of claim 9, wherein the bars are substantially straight.

11. The method of claim 9, wherein the bars are curved to conform to a shape of a clock; and positions of ends of the bars relative to the clock indicate departure and arrival times of corresponding travel options represented by the bars.

12. The method of claim 3, wherein on the bars the chart shows transportation carriers associated with the travel time periods represented by the bars.

13. The method of claim 12, wherein the transportation carriers are represented by icons on the bars.

14. The method of claim 3, wherein the chart includes a column to indicate transpiration carriers associated with the travel time periods represented by the bars.

15. The method of claim 14, wherein the chart further includes at least one column to list at least one of: gate information, seat availability, and availability of flight connections.

16. (canceled)

17. The method of claim 1, wherein the timescale includes a common clock for representations of travel times.

18. (canceled)

19. A machine readable media embodying instructions, the instructions causing a computer system to perform a method, the method comprising:
receiving a search request from a phone of a user, the phone configured to run a calendar application and storing calendar items compatible for use with the calendar application, and the calendar items to include a plurality of scheduled events of the user;
determining, via a server, a plurality of travel options in response to the search request; and
sending, from the server, a presentation to the phone, the presentation to display the travel options using a chart having a dimension graphically representing travel times of the travel options, the dimension including a timescale, and wherein at least one of the scheduled events is displayed on the timescale.

20. A computer system, comprising:
a means for receiving a search request from a device of a user, the device running a calendar application to display a plurality of pre-existing scheduled items of the user;
a means for determining, via a server, a plurality of travel options in response to the search request; and
a means for sending, from the server, a presentation to the device, the presentation to display the travel options using a chart having a dimension graphically representing travel times of the travel options, wherein the dimension includes a timescale, and the chart includes a plurality of bars graphically representing travel time periods between departure and arrival of the travel options, and wherein the presentation is to further display at least one of the scheduled items on the timescale.
